(19) United States
(12) Patent Application Publication
(10) Pub. No.: US 2008/0177704 A1
(43) Pub. Date: Jul. 24, 2008

(54) Utilizing Tags to Organize Queries

(75) Inventors: Justin Denney, Seattle, WA (US); Jason Wodicka, Seattle, WA (US); Gianluca Donato, Sunnyvale, CA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/626,741

(22) Filed: Jan. 24, 2007

(51) Int. Cl. G06F 17/30

(52) U.S. Cl. 707/3

(57) ABSTRACT

Computer-readable media, systems, and user interfaces for organizing queries are described. In embodiments, a query is received, associated with at least one tag, and stored in association therewith. In one embodiment, to determine at least one relevant tag to associate with the query, the received query is analyzed based upon unit frequency and/or relative unit proximity. The unit frequency and/or relative unit proximity is compared to similar measures associated with a plurality of other queries to determine at least one related query. The received query is then associated with at least one tag associated with the related query.

### BACKGROUND

The Internet provides a vast amount of resources that may be searched to find information pertaining to various issues or queries. However, even though a vast amount of information may be available on the Internet, the specific information desired by a user may be difficult to locate. As the Internet continues to develop, several applications are evolving that provide resources for query information. More specifically, web applications exist that allow entities to prepare and post queries and responses to queries.

Unfortunately, a problem with the several applications that are evolving is their ineffective method of routing queries to potential answerers and organizing the content into sets of knowledge that relate to a particular subject matter. One common solution is to organize queries into categories. Organizing queries by category, however, has several limitations. For example, there may be multiple categories available to file a query under, but the system only allows selection of one category. Additionally, when there are multiple category choices, it is not clear to the user of the applications which category will contain the most related questions. Further, experts who look for queries in one category fail to find highly related queries in other categories.

### SUMMARY

Embodiments of the present invention provide systems, methods and user interfaces for organizing query information with tags. For example, in one embodiment, an organizing engine uses tag(s) to organize one or more queries. The one or more queries are associated with the tag(s) and stored in association with the tag(s). Using tags to organize queries provides a number of advantages to the user including more efficient navigation through and searching of queries.

It should be noted that this Summary is provided to generally introduce the reader to one or more select concepts described below in the Detailed Description in a simplified form. This Summary is not intended to identify key and/or required features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing system environment suitable for use in implementing embodiments of the present invention;

FIG. 2 is a block diagram illustrating an exemplary system for organizing queries, in accordance with an embodiment of the present invention;

FIG. 3 is a block diagram illustrating an exemplary system for organizing queries, in accordance with an embodiment of the present invention; the system having more detail than the system of FIG. 2;

FIG. 4 is a flow diagram illustrating an exemplary method for organizing queries, utilizing at least one tag, in accordance with an embodiment of the present invention;

FIG. 5 is a flow diagram illustrating an exemplary method for organizing queries and responses thereto, in accordance with an embodiment of the present invention;

FIG. 6 is a flow diagram illustrating an exemplary method for organizing queries, utilizing tag(s) and permitting subscription to such tag(s), in accordance with an embodiment of the present invention;

FIG. 7 is a flow diagram illustrating an exemplary method for organizing queries by comparison to other related queries, in accordance with an embodiment of the present invention;

FIG. 8 is a flow diagram illustrating an exemplary method for organizing queries based upon user selection, in accordance with an embodiment of the present invention;

FIG. 9 is a flow diagram illustrating an exemplary method for organizing queries utilizing confidence score based suggestions and user selection, in accordance with an embodiment of the present invention;

FIG. 10 is a flow diagram illustrating an exemplary method for organizing queries based upon user-identified tags, in accordance with an embodiment of the present invention;

FIG. 11 is an exemplary display of a graphical user interface for permitting user input of a desired query, in accordance with an embodiment of the present invention;

FIG. 12 is an exemplary display of a graphical user interface for permitting user input with respect to tagging a query, in accordance with an embodiment of the present invention;

FIG. 13 is an exemplary display of a graphical user interface for presenting organized query information, in accordance with an embodiment of the present invention; and

FIG. 14 is an exemplary display of a graphical user interface for presenting organized query information, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computer-readable media, systems and user interfaces for organizing queries. In various embodiments an organizing engine receives one or more queries through a question and answer environment and associates the one or more queries with relevant tag(s). Further, in various embodiments, the received one or more queries are stored in association with the tag(s). While embodiments discussed herein refer to accessing web pages on the Web via the Internet, it will be understood by one of ordinary skill in the art that embodiments are not limited to the Internet. For example, other embodiments may access electronic documents via a private network.

Accordingly, various embodiments of the present invention are directed to one or more computer-readable media having computer-executable instructions for performing a method for organizing queries. The method includes receiving a query, associating at least one tag with the received query, and storing the query in association with the at least one tag.

In other embodiments, the present invention is directed to a system for organizing queries received through a question and answer environment. The system includes at least one database, a receiving component, and a query tagging component. The at least one database is configured to store at least one query in association with at least one related tag. Additionally, the at least one database is searchable for one or more of the queries and tags. The receiving component is configured to receive at least one query through a question and answer environment. Further, the query tagging component is configured to associate the at least one query with at least one tag.

In yet another embodiment, the present invention is directed to a user interface for associating at least one tag with a query. The user interface includes a query display area, a suggested tag display area, and a related queries display area. The query display area is configured to display at least one received query. The suggested tag display area is configured to display at least one tag suggested for association with the received query. The related queries display area is configured to display at least one query related to the received query.

The term “tag,” as the term is utilized herein, may be a word or a character string that is related to a query. In various embodiments of the present invention, tags include, without limitation, words or character strings within the query or descriptive of the query. Tags also include, without limitation, words or character strings associated with a related query. Further, tags include, without limitation, words or character strings entered and/or selected by a user.

Having briefly described an overview of embodiments of the present invention, an exemplary operating environment is described below.

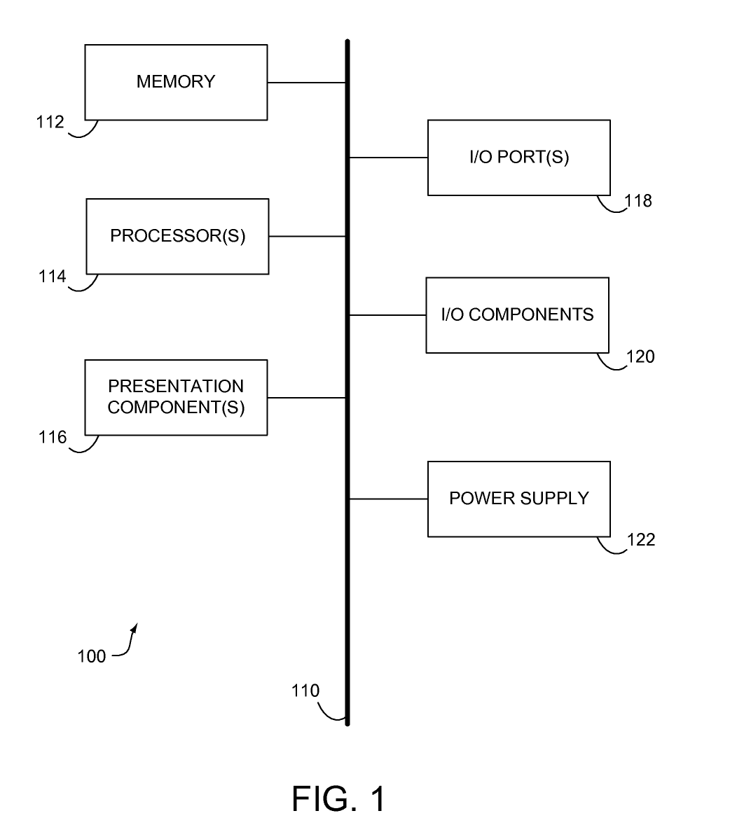

Referring to the drawing figures in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the present invention may be described in the general context of computer code or machine-usable instructions, including computer-executable instructions such as program modules, being executed by a computer or other machine, such as a personal data assistant or other handheld device. Generally, program modules including routines, programs, objects, components, data structures, and the like, refer to code that performs particular tasks or implements particular abstract data types. Embodiments of the invention may be practiced in a variety of system configurations, including, but not limited to, hand-held devices, consumer electronics, general purpose computers, specialty computing devices, and the like. Embodiments of the invention may also be practiced in distributed computing environments where tasks are performed by remote processing devices that are linked through a communications network. In a distributed computing environment, program modules may be located in association with both local and remote computer storage media including memory storage devices. The computer useable instructions form an interface to allow a computer to react according to a source of input. The instructions cooperate with other code segments to initiate a variety of tasks in response to data received in conjunction with the source of the received data.

Computing device 100 includes a bus 110 that directly or indirectly couples the following elements: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. Thus, it should be noted that the diagram of FIG. 1 is merely illustrative of an exemplary computing device that may be used in connection with one or more embodiments of the present invention. Distinction is not made between such categories as “workstation,” “server,” “laptop,” “hand held device,” etc., as all are contemplated within the scope of FIG. 1 and reference to the term “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer storage media in the form of volatile and/or nonvolatile memory. The memory may be removable, nonremovable, or a combination thereof. Exemplary hardware devices include solid state memory, hard drives, optical disc drives, and the like. Computing device 100 includes one or more processors that read from various entities such as memory 112 or I/O components 120. Presentation component(s) 116 present data indications to a user or other device. Exemplary presentation components include a display device, speaker, printing component, vibrating component, and the like.

I/O ports 118 allow computing device 100 to be logically coupled to other devices including I/O components 120, some of which may be built in. Illustrative components include a microphone, joystick, game pad, satellite dish, scanner, printer, wireless device, etc.

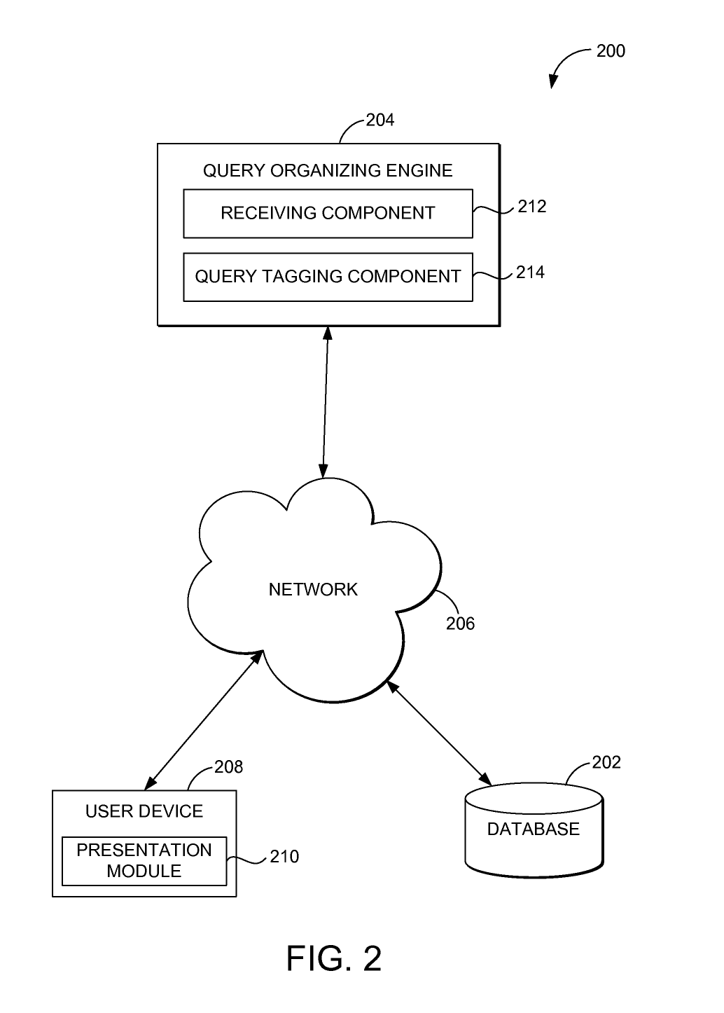

Turning now to FIG. 2, a block diagram is provided illustrating an exemplary system 200 for organizing queries, in accordance with an embodiment of the present invention. The system 200 includes a database 202, a query organizing engine 204, and a user device 208 in communication with one another via a network 206. The network 206 may include, without limitation, one or more local area networks (LANs) and/or wide area networks (WANs). Such networking environments are commonplace in offices, enterprise-wide computer networks, intranets, and the Internet. Accordingly, the network 206 is not further described herein.

The database 202 is configured to store information associated with at least one query and at least one tag. In various embodiments, such information may include, without limitation one or more queries comprising a character or a string of characters and one or more tags comprising a character or a string of characters. For example, without limitation, a query received by a user may be a word, question, or statement designed to elicit a response originating from another user. Accordingly, in various embodiments, the query is received through a question and answer environment. Tags may include, by way of example only, one or more character strings from the query, one or more character strings descriptive of the query, one or more character strings associated with a related query or queries, one or more character strings selected by a user, and one or more character strings input by the user. In various embodiments, the database 202 is configured to be searchable for one or more queries and/or one or more tags stored in association therewith. It will be understood and appreciated by those of ordinary skill in the art that the information stored in the database 202 may be configurable and may include any information relevant to the query or tag and/or the placement thereof. The content and volume of such information are not intended to limit the scope of embodiments of the present invention in any way. Further, though illustrated as a single, independent component, database 202 may, in fact, be a plurality of databases, for instance, a database cluster, portions of which may reside on a computing device associated with the query organizing engine 204, on the user device 208, on another external computing device (not shown) or any combination thereof.

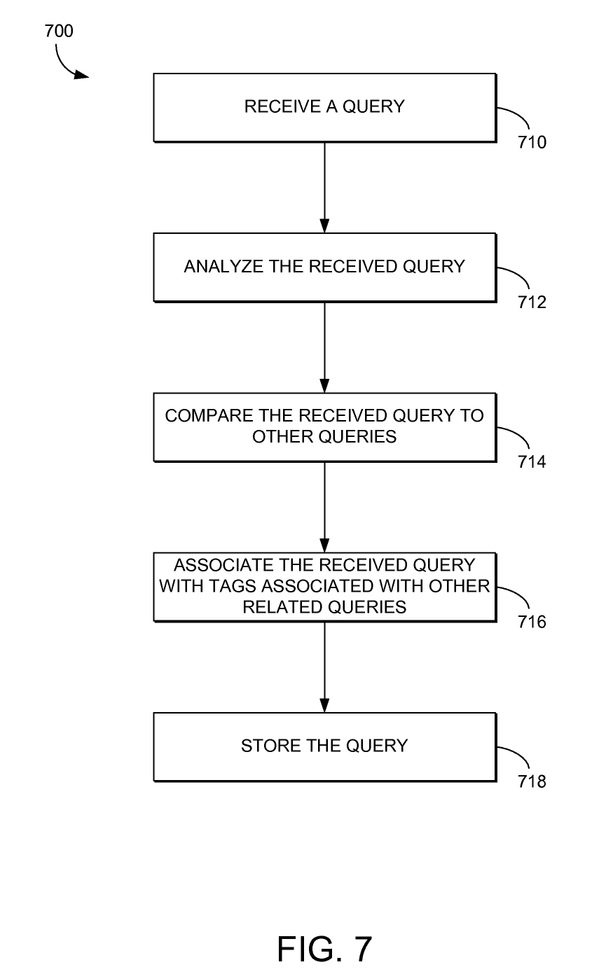

The query organizing engine 204 includes a receiving component 212 and a query tagging component 214 and is configured to operate utilizing at least a portion of the information stored in database 202. The receiving component 212 is configured to receive at least one query through a question and answer environment. The query tagging component 214 is configured to associate the at least one query with at least one tag. In various embodiments, the query tagging component 214 is configured to analyze the received query based upon at least one of unit frequency and relative unit proximity. In various embodiments, by way of example, the “unit” includes one or more characters from the received query. In such embodiments the query tagging component 214 compares the unit frequency and/or relative unit proximity to similar measures related to a plurality of other queries stored in database 202. The query tagging component 214 then determines one or more queries from the plurality of queries that is most closely related to the received query and associates the received query with at least one tag associated with the related query or queries based upon a variety of criteria, some of which are more fully described below with reference to FIG. 7.

The user device 208 may be any type of computing device, such as computing device 100 described with reference to FIG. 1, for example, and includes at least one presentation module 210 configured to present (e.g. display) one or more queries and their association with one or more tags. In this regard, presentation module 210 may be configured to receive query and tag information, for instance, from database 202, and utilize such query and tag information upon presenting queries and tags. Such embodiments are more fully described herein below. Additionally, other components not shown may also be included within any of the system 200, the database 202, the query organizing engine 204, and the user device 208. Any and all such variations are contemplated to be within the scope of embodiments hereof.

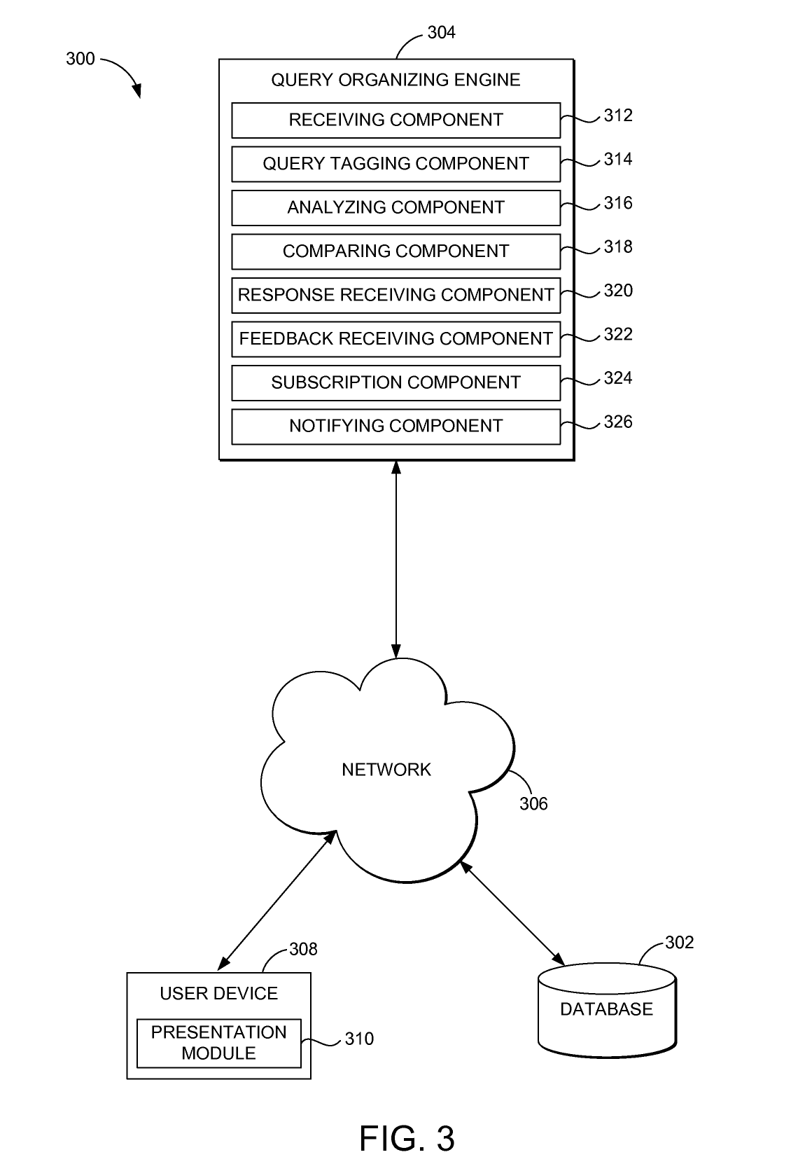

Turning now to FIG. 3, a block diagram is provided illustrating an exemplary system 300 for organizing queries, the system 300 having more detail than the system 200 of FIG. 2, in accordance with an embodiment of the present invention. The system 300 shown in FIG. 3 includes a database 302, a query organizing engine 304, and a user device 308 in communication with one another via a network 306. As with the network 206, the network 306 may include, without limitation, one or more local area networks (LANs) and/or wide area networks (WANs). Such networking environments are commonplace in offices, enterprise-wide computer networks, intranets, and the Internet. Accordingly, the network 306 is not further described herein.

The query organizing engine 304 includes various components and is configured to operate utilizing at least a portion of the information stored in the database 302. The query organizing engine 304 includes a receiving component 312, a query tagging component 314, an analyzing component 316, a comparing component 318, a response receiving component 320, a feedback receiving component 322, a subscription component 324, and a notifying component 328. The receiving component 312 is configured to receive at least one query through a question and answer environment.

The query tagging component 314 is configured to associate the at least one query with at least one tag. The analyzing component 316 is configured to analyze the received query based upon a unit frequency and/or a relative unit proximity.

The comparing component 318 is configured to compare the unit frequency and/or relative unit proximity to similar measures associated with one or more other queries to determine one or more queries that are closely related to the received query. In various embodiments, the receiving component 312 receives queries from users including, but not limited to, a user of any type of computing device, such as computing device 100 described with reference to FIG. 1, for example. The unit may include, but is not limited to, a single character or a string of characters. Further, the query tagging component 314 is configured to associate the received query with the tags associated with the related query(ies).

Response receiving component 320 is configured to receive, through a question and answer environment, at least one response to a received query from a response author. Additionally, the feedback receiving component 322 is configured to receive feedback related to the responses to the received query. In other embodiments, the feedback receiving component 322 may further be configured to rank a response author based upon the feedback to the response author's responses. In various embodiments, the feedback may be a comment regarding the response comprising a character or string of characters. In various other embodiments, the feedback may be a ranking of the response author based on the usefulness of the response. In yet other embodiments, the feedback may be a request to remove the response from association with the query if the response is incorrect or not useful.

The subscription component 324 is configured to receive subscription information from a user. For example, in various embodiments, the user may wish to subscribe to a particular tag. The subscription component 324 will receive the subscription request and associate the user with the subscribed tag. Further, notifying component 326 will alert the user when a query or response to a query is received and associated with the subscribed tag. For example, in various embodiments, the notifying component may alert the user by sending an e-mail text message, sending a text message to the user's cellular or other phone, calling the user's cellular or other phone, and posting an alert on the user's personalized query account to alert the user when the user signs on. The content and volume of such information are not intended to limit the scope of embodiments of the present invention in any way.

As previously mentioned, the system 300 further includes a user device 308 in communication with the database 302 and the query organizing engine 304 via the network 306. The user device 308 may be associated with any type of computing device, such as computing device 100 described with reference to FIG. 1, for example. The user device 308 further includes at least one presentation module 310 configured to present (e.g. display) one or more queries in association with one or more tags. In this regard, presentation module 310 may be configured to receive query and tag information, for instance, from database 302, and utilize such query and tag information upon presenting queries and tags. Such embodiments are more fully described herein below. Additionally, other components not shown may also be included with the system 300. Further additional components not shown may also be included within any of the database 302, the query organizing engine 304, and the user device 308. Any and all such variations are contemplated to be within the scope of embodiments hereof.

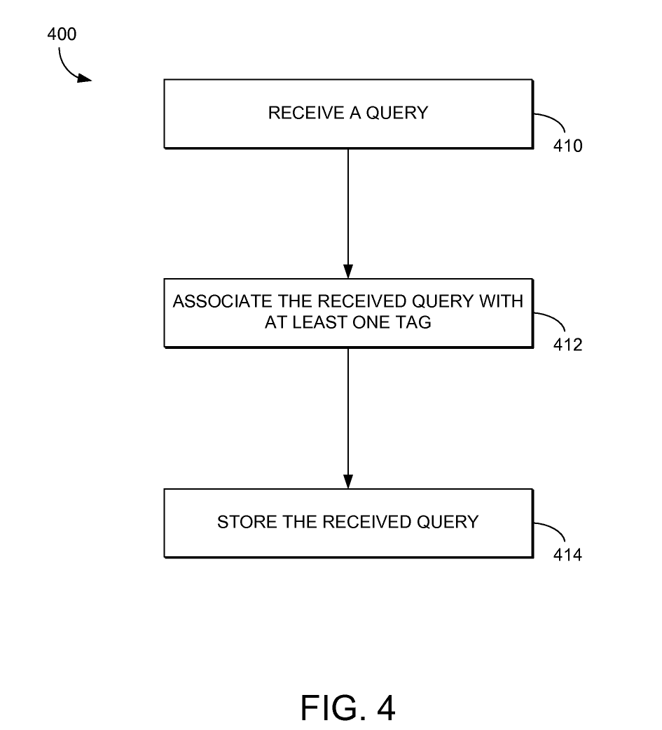

Turning now to FIG. 4, a flow diagram of an exemplary method for organizing queries utilizing at least one tag, in accordance with an embodiment of the present invention, is illustrated and designated generally as reference numeral 400. Initially, as indicated at block 410, a query is received, e.g., by receiving component 312 of FIG. 3. By way of example, the received query may be a string of characters input into a computing device such as computing device 100 described above with reference to FIG. 1. In various embodiments, the query is received through a question and answer environment. For example, without limitation, the query may be input by a user in a question and answer environment and the query may be a word, question, or statement, designed to elicit a response originating from another user. For instance, a user of a computing device might input the query “What is the best cure for the common cold?”.

Next, as indicated at block 412, one or more tags relevant to the query is associated therewith. As previously described, tags may be character strings that are taken directly from the received query, descriptive of the received query, and/or associated with one or more related queries. For example, using the above exemplary query, the tags “health” and “home” may be associated with the received query.

Next, as indicated at block 414, the received query is stored, for instance in a database such as database 202 of FIG. 2. In embodiments, the received query is stored in association with the one or more tags associated with the query. For instance, keeping with the above example, the query “What is the best cure for the common cold?” may be stored in association with the tags “health” and “home.”

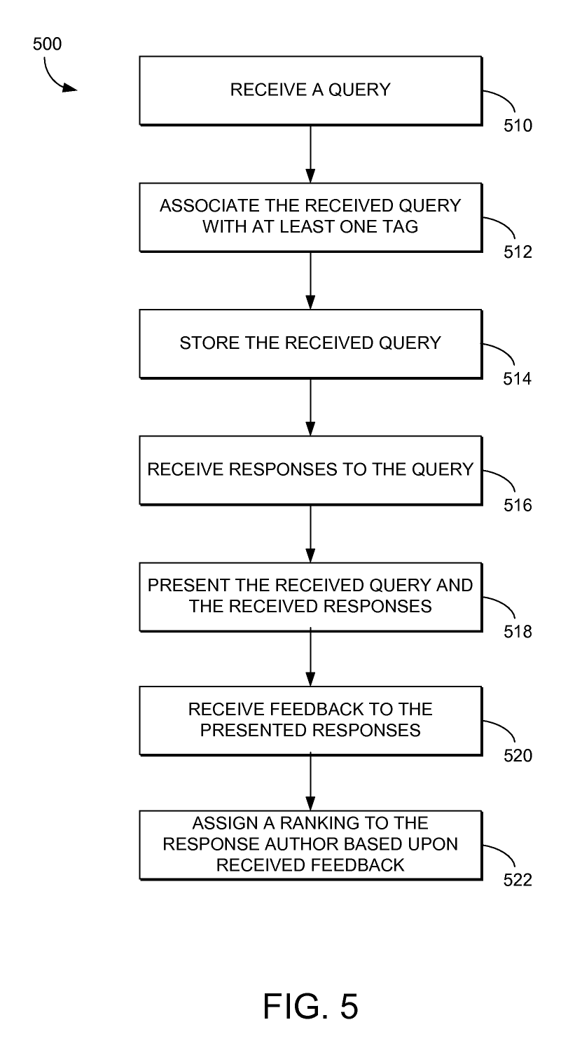

Turning now to FIG. 5, a flow diagram of an exemplary method for organizing queries and responses thereto, in accordance with an embodiment of the present invention, is illustrated and designated generally as reference numeral 500. Initially, as indicated at blocks 510, 512, and 514 respectively, a query is received, associated with at least one tag and, stored as previously discussed with regard to steps 410, 412, and 414 of FIG. 4.

Next, as indicated at block 516, one or more responses to the query is received, e.g., utilizing response receiving component 322 of FIG. 3. In various embodiments an author of a response may be a user of a query web site. For example, without limitation, a query author may be a person submitting a query on a query site who happens to notice another query about a subject within their knowledge. In other embodiments, the author of a response may be a designated expert that routinely answers questions in a particular field. In yet other embodiments, a response author may be an employee who answers questions for other employees in a local network. For example, without limitation, IT personnel might answer queries for users of a business computer system. In yet other embodiments, the response author may be a computer system configured to respond to queries. Any and all such variations, and combinations, thereof are contemplated to be within the scope of embodiments of the present invention.

Next, as indicated at block 518, the received query and the received response(s) are presented, e.g., utilizing presentation module 310 of FIG. 3. The received query and the received response may be presented in a variety of ways. For example, the received query and the received response may be displayed in a pop-up window, presented through an overlay window, through a text line within a media play window, via an email sent to the user, and/or presented verbally through a system speaker. Any and all such variations, and any combinations thereof, are contemplated to be within the scope of embodiments hereof.

Next, as indicated at block 520, feedback to the presented responses is received, e.g., utilizing feedback receiving component 324. The feedback to the presented responses may be in a variety of forms. For example, the feedback may be a rating of the helpfulness of the presented response to the received query. In another example, the feedback may be in the form of comments regarding the presented response. In yet another example, verbal feedback may be received involving the presented response. Any and all such variations, and combinations thereof, are contemplated to be within the scope of embodiments of the present invention.

Next, as indicated at block 522, a ranking is assigned to the response author based upon the received feedback. For example, the response author may receive points toward an “expert score” in association with a tag where the response author's response is rated as very helpful and relevant according to the received feedback. The response author may accumulate points over time and attain expert status. Additionally, once the response author has been classified as an expert, any further responses received by the response author may be denoted as such when the received queries and responses are presented (i.e. at block 518). In another example, the response author may lose expert points where the response author's responses receive negative feedback. In yet another example, the response author may be ranked for comparison with other response authors according to the response author's expert score. As will be understood by one of ordinary skill in the art, ranking response authors will allow users of a query organizing system of the present invention to assess the likely reliability of a response based on the score or ranking of the response author.

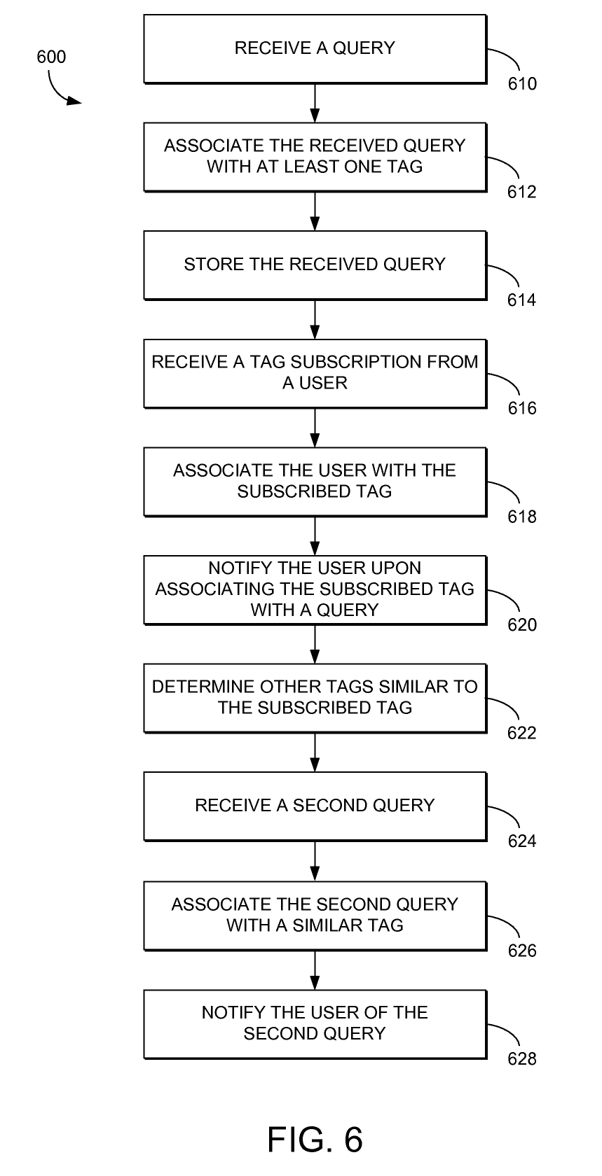

Turning now to FIG. 6, a flow diagram of an exemplary method for organizing queries utilizing tags and permitting subscription to such tags, in accordance with an embodiment of the present invention, is illustrated and designated generally as reference numeral 600. Initially, as indicated at blocks 610, 612, and 614, respectively, a query is received, associated with at least one tag, and stored as previously discussed with regard to steps 410, 412, and 414 of FIG. 4.

Next, as indicated at block 616, an indication that a user desires to subscribe to a particular tag is received. Subsequently, the user is associated with the subscribed tag, as indicated at block 618. Next, upon association of the subscribed-to tag with a newly received query, the user is notified as indicated at block 620. For example, if a user desires to be associated with a “health” tag, and subscribes thereto, the user will receive a notification each time a query is received and associated with the “health” tag. The user may desire to be associated with a tag for a variety of reasons. As an example, the user may be an expert in a particular field and desire to submit responses to queries in the field. Alternatively, the user may be interested in a specific topic and may wish to monitor queries and responses related to that topic.

Next, as indicated at block 622, it is determined whether any other tags (for instance tags stored in database 302 of FIG. 3) are similar to the subscribed-to tag. If it is determined that one or more tags are similar to the subscribed-to tag, such similar tags are stored in association with an ID of the user and the subscribed-to tag (e.g., in database 302 of FIG. 3).

Subsequently, suppose a second query is received, as indicated at block 624, and associated with a similar tag, as indicated at block 626. Upon such association, the user will be notified of the second query. This is indicated at block 628. This similar tag notification feature allows a user to be apprised of a breadth of queries in a particular field. For example, if the user subscribes to the “health” tag, the user may also want to be notified of any queries associated with the “medicine” tag, even though s/he has not expressly subscribed thereto.

Turning now to FIG. 7, a flow diagram of an exemplary method for analyzing and organizing queries, in accordance with an embodiment of the present invention, is illustrated and designated generally as reference numeral 700. Initially, as indicated at block 710, a query is received, e.g., utilizing receiving component 312 of FIG. 3. Next, as indicated at block 712, the received query is analyzed based upon unit frequency and/or relative unit proximity (such analysis techniques being described hereinafter with respect to analyzing component 316 of FIG. 3). Next, as indicated at block 714 the unit frequency and/or relative unit proximity is compared to similar measures derived from a plurality of other queries to determine at least one query that is closely related to the received query. Subsequently, as indicated at block 716, at least one tag associated with the related query is associated with the received query. The query is then stored in association with the tag, as indicated at block 718. For example, if the received query is “What is the best cure for the common cold?”, the related query might be “How to cure a common cold?”. In various embodiments, the method for organizing queries will associate “What is the best cure for the common cold?”, with one or more tags already associated, e.g. in association with database 302 of FIG. 3, with the query “How to cure the common cold?”.

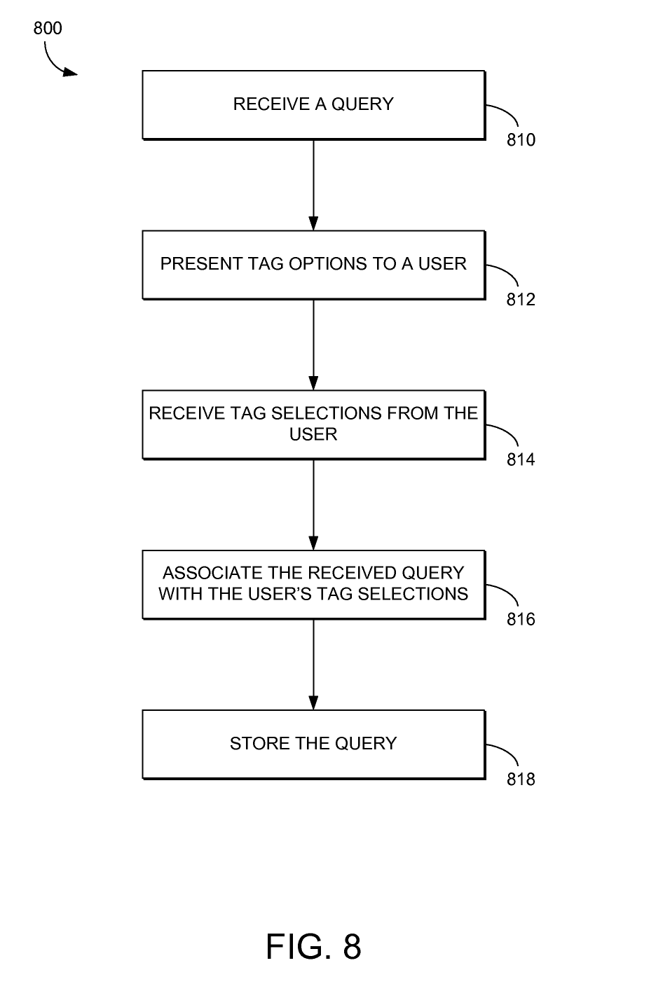

Turning now to FIG. 8, a flow diagram of an exemplary method for organizing queries based upon user-selected tagging, in accordance with an embodiment of the present invention, is illustrated and designated generally as reference numeral 800. Initially, as indicated at block 810, a query is received, for instance utilizing receiving component 312 of FIG. 3. Subsequently, as indicated at block 812, one or more tag options are presented to the user at block 812 and tag selections are received from the user (e.g., utilizing presentation module 310 of FIG. 3) and such tag selections are received at block 814. Subsequently, as indicated at block 816, the received query is associated with the user-selected tag for example, utilizing query tagging component 314 of FIG. 3 as indicated, and the received query is stored in association with such tag(s) (e.g. in association with database 302 of FIG. 3) as indicated at block 818. Thus, in various embodiments, the user can designate the tags that are associated with a particular query. In these embodiments, the user may determine how the query is organized and effectively target the query to potential response authors.

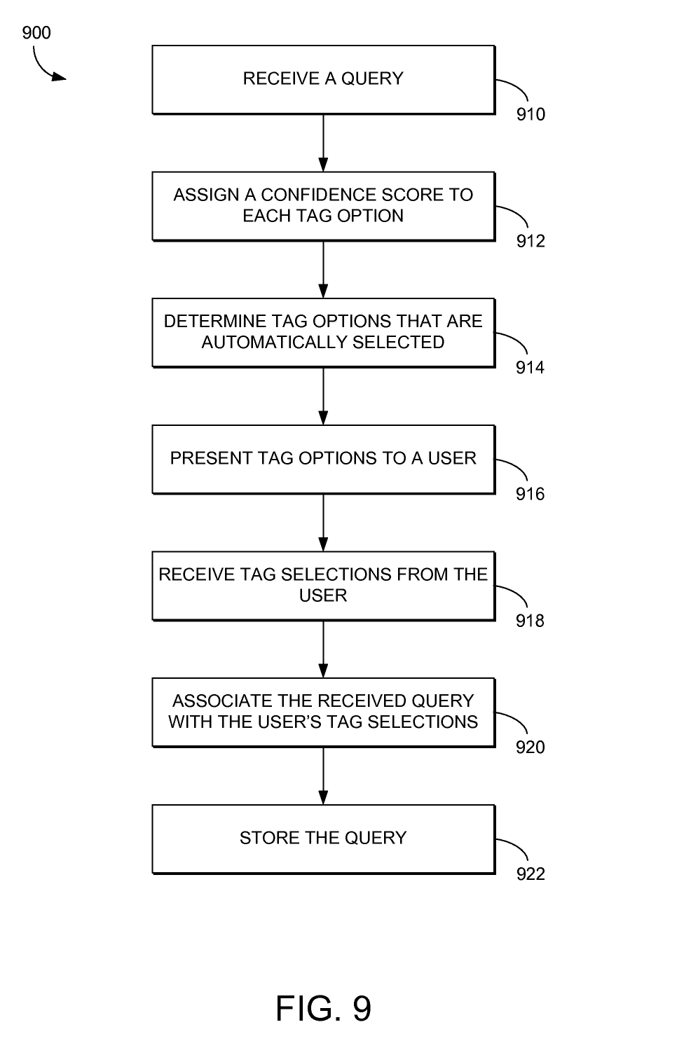

Turning now to FIG. 9 a flow diagram of an exemplary method for organizing queries via automatic tag association and user interaction, in accordance with an embodiment of the present invention, is illustrated and designated generally as reference numeral 900. Initially, as indicated at block 910 a query is received, e.g., utilizing receiving component 312 of FIG. 3. Subsequently, a confidence score is associated with each of a plurality of tag options indicated at block 912 and, based on the confidence score, one or more of the tag options is automatically selected for association with the received query. This is indicated at block 914. All tag options are then presented to the user, e.g., via presentation module 310 with a visual indication being associated with the tag(s) that has been automatically selected based on the confidence score. This is indicated at block 916. In various embodiments, the user may select additional tags to be associated with the received query. Additionally, in these embodiments, the user may de-select tags that were automatically selected if the user does not desire to associate the received query with the automatically selected tag(s). The user's tag selections are received, as indicated, at block 918, and the received query is associated with one or more tags according to the user's tag selections and/or confirmations, as indicated at block 920. Next, as indicated at block 922, the received query is stored in association with the selected tags, e.g., in database 302 of FIG. 3.

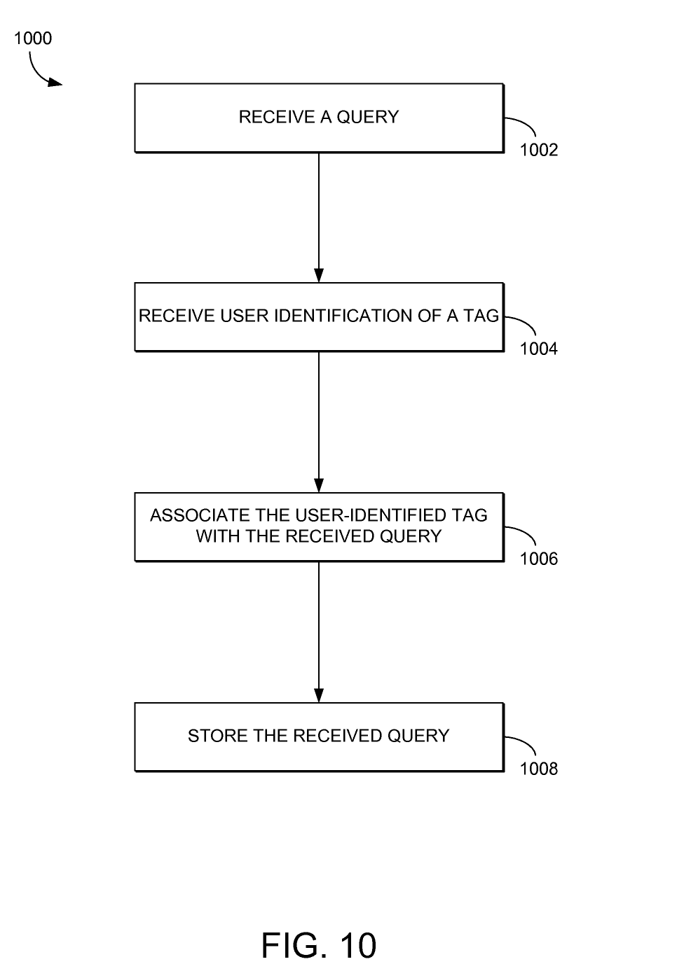

Turning now to FIG. 10, a flow diagram of an exemplary method for organizing queries based upon user-identified tags, in accordance with an embodiment of the present invention, is illustrated and designated generally as reference numeral 1000. Initially, as indicated at block 1002 a query is received, e.g., utilizing receiving component 312 of FIG. 3. Subsequently, user identification of a tag is received, e.g., using the query tagging component 314 of FIG. 3 as indicated at block 1004. For example, in various embodiments, a user may input a tag for association with the received query when the user initially submits the query. In various other embodiments, the user may input a tag for association with the received query into a text box displayed to the user. Thus, the user may control the association of the received query with one or more tags rather than being limited to automatically suggested tags or existing, pre-defined tags. Subsequently as indicated at block 1006, the user-identified tag is associated with the received query and, as indicated at block 1008, the received query is stored in association with one or more tags, e.g., in association with database 302 of FIG. 3.

In each of the exemplary methods described herein, various combinations and permutations of the described blocks or steps may be present and additional steps may be added. Further, one or more of the described blocks or steps may be absent from various embodiments. It is contemplated and within the scope of the present invention that the combinations and permutations of the described exemplary methods, as well as any additional or absent steps, may occur. The various methods are herein described for exemplary purposes only and are in no way intended to limit the scope of the present invention.

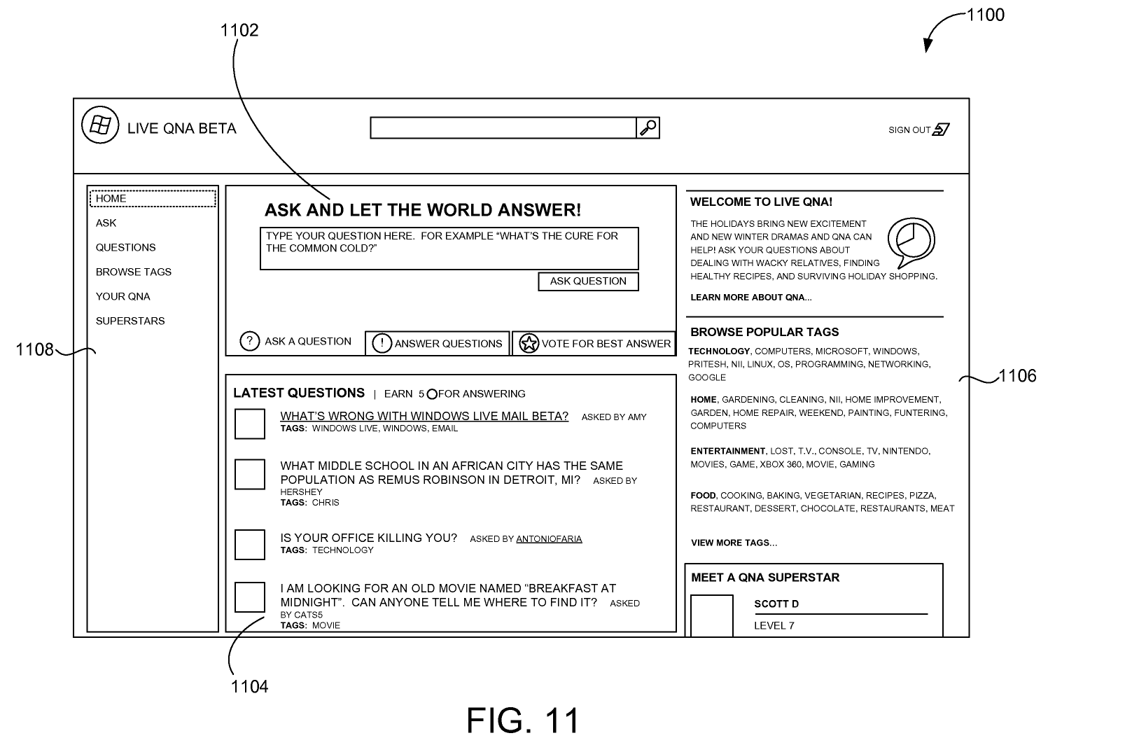

FIGS. 11-14 illustrate exemplary displays of graphical user interfaces that may be utilized in accordance with a query organizing system, according to embodiments of the present invention. The query organizing system may include any electronic display of a forum for displaying and responding to queries. One skilled in the art will understand that numerous web browsers are available with varying feature orientations. Accordingly, embodiments are not limited to any standard buttons, toolbars, menus, or orientation of hyperlinks. Further, a user can interact with the displayed query organizing system using well-known input components such as, for example, a mouse, joystick, stylus, touch screen, or the like.

Query organizing systems in accordance with embodiments of the present invention, facilitate display of a forum (generally referenced in FIG. 11 as 1100) which allows users to prepare and post queries, associate queries with tags, and search queries. Turning to FIG. 11, a graphical user interface is shown and designated generally as display 1100. Display 1100 includes a query receipt area 1102, a latest query display area 1104, a popular tag display area 1106, and a navigation area 1108. The query receipt area 1102 is configured to prompt the user to submit a query, if the user desires to do so. In the query receipt area 1102, the user can input a query into a text box. Upon preparing a query in the query receipt area 1102, if desired, the user may select the “ask question” indicator to submit the query to the query organizing system. In various embodiments, the query receipt area 1102 receives queries through a question and answer environment. For example, without limitation, the query may be input by a user in a question and answer environment and the query may be a word, question, or statement designed to elicit a response originating from another user.

The latest query display area 1104 is configured to display recent queries received by the query organizing system. The latest query display area 1104 allows the user to select recent queries and explore any responses thereto. Additionally, after selecting a query from the latest query display area 1104, the user can respond to the query, if desired.

The popular tag display area 1106 is configured to present popular tags to the user. In various embodiments, by selecting one of the presented popular tags, the user is directed to one or more queries associated with the selected tag. In other embodiments, the user may select a category of tags, designated as bold, underlined, or otherwise distinguished from the rest of the presented tags.

The navigation area 1108 is configured to allow the user of the query organizing system to access various functionality. In various embodiments, the navigation area allows the user to ask a question by presenting a query or to review queries submitted by other users. In other embodiments, the navigation area 1108 is configured to allow the user to browse various tags by category. Further, the user can review associated queries by selecting various tags. In yet other embodiments, the navigation area 1108 is configured to allow the user to explore the user's individualized query information. For example, the user can review any queries that the user has submitted to the query organizing system. Additionally, as an example, the user can review any responses the user has submitted to the query organizing system. Further, in embodiments, the user can access alerts that have been sent to the user based upon the user's association with one or more tags. For example, if the user has subscribed to the “health” tag, any queries received by the query organizing system associated with the “health” tag will be presented to the user when the user navigates to alerts via the navigation area 1108.

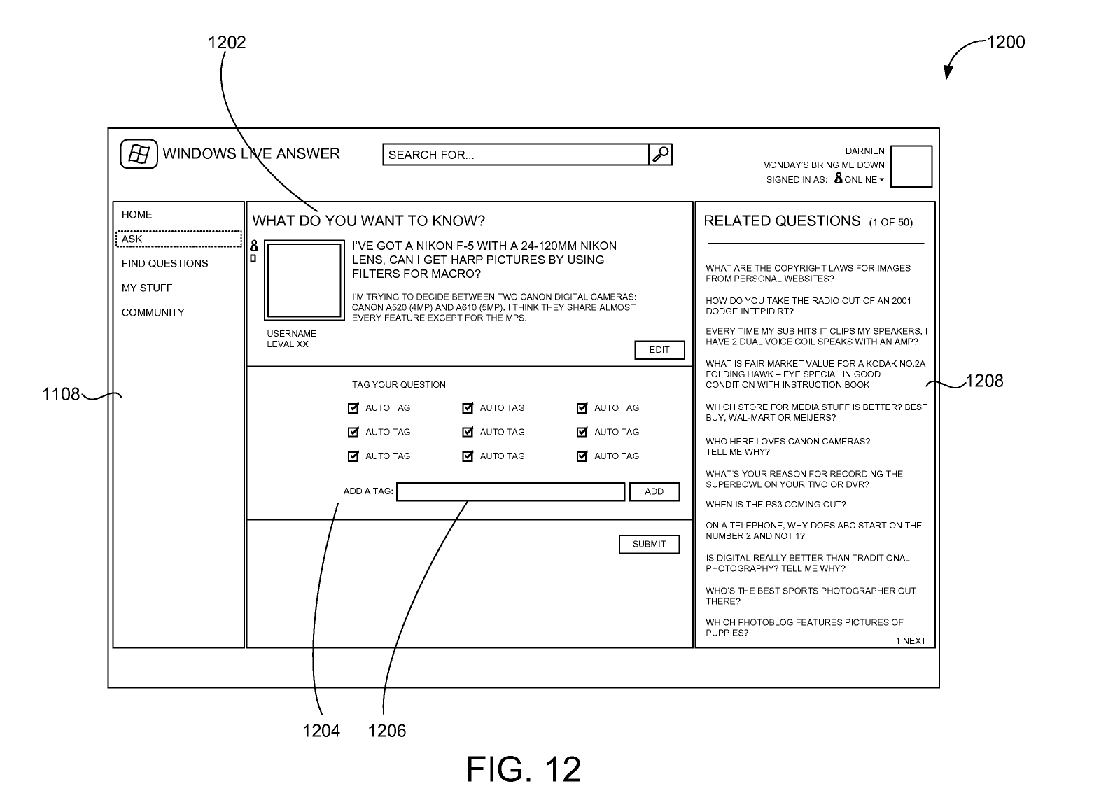

Referring now to FIG. 12, a graphical user interface for a query organizing system, according to embodiments of the present invention is generally illustrated and designated as reference numeral 1200. Display 1200 includes a query display area 1202, a suggested tag display area 1204, a user input display area 1206, and a related queries display 1208. The query display area 1202 is configured to display the query received by the query organizing system. The suggested tag display area 1204 is configured to display tags that the query organizing system determines are related to the received query. In various embodiments, the query organizing system will automatically select related tags and present the selected and unselected related tags to the user in the suggested tag display area 1204. In other various embodiments, the suggested tag display area may include a user input receipt area 1206 that is configured to allow the user to input one or more additional tags. The related queries display area 1208 is configured to display queries related to the received query. The user can review any of the related queries and responses thereto.

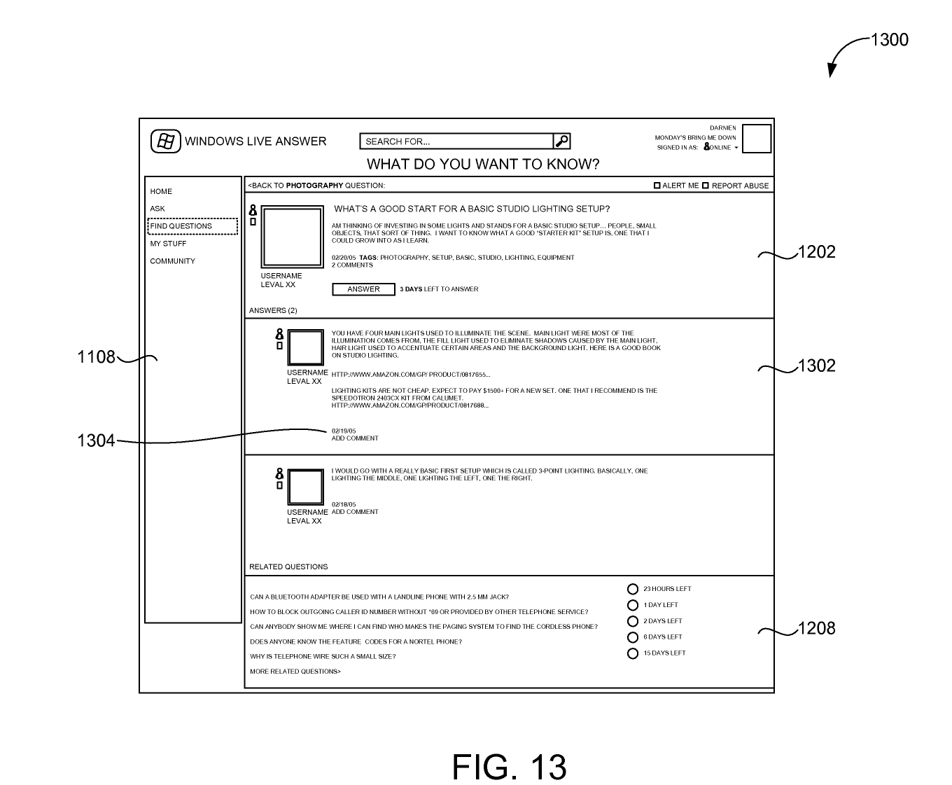

Referring now to FIG. 13, a graphical user interface for a query organizing system, according to embodiments of the present invention is generally illustrated and designated as reference numeral 1300. Display 1300 includes a response display area 1302 and a selectable feedback indicator 1304. The response display area 1302 is configured to present responses to the received query that have been received by the query organizing system. For example, in various embodiments, the response display area 1302 will display responses to the received query, feedback to the response, and information about the response author. Further, in various embodiments the response display area 1302 may include a selectable feedback indicator 1304, selection of which permits the user to provide feedback related to the displayed response.

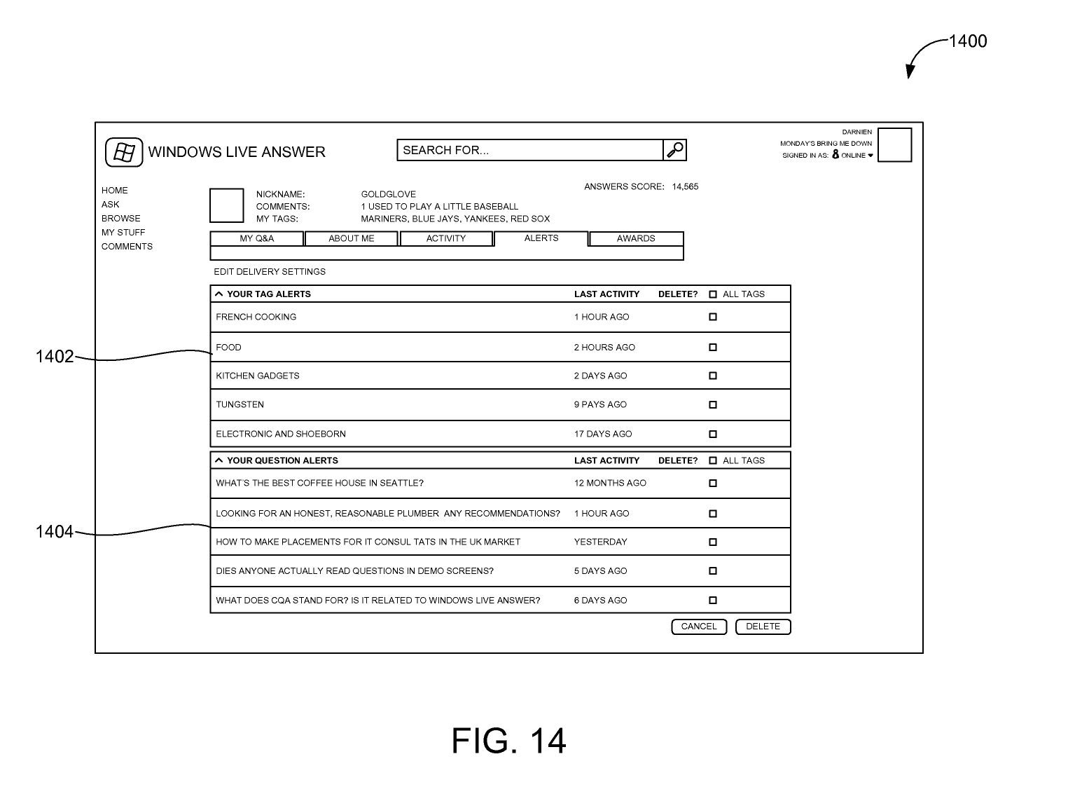

Referring now to FIG. 14, a graphical user interface for a query organizing system, according to embodiments of the present invention is generally illustrated and designated generally as reference numeral 1400. Display 1400 includes a tag alert area 1402 and a question alert area 1404. The tag alert area 1402 is configured to display one or more tags to which the user has subscribed. Additionally, in various embodiments, the tag alert area 1402 is configured to display any activity in the query organizing system associated with the subscribed-to tag. Further, the question alert area 1404 is configured to display queries to which the user desires to be subscribed. For example, in various embodiments, the question alert area 1404 may include queries input by the user, or queries to which the user has provided a response. Thus, the tag alert area 1402 and the question alert area 1404 are configured to allow the user to be apprised of activity related to tags and queries in which the user is interested.

The present invention has been described herein in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain the ends and objects set forth above, together with other advantages which are obvious and inherent to the methods, computer-readable media, and graphical user interfaces. It will be understood that certain features and subcombinations are of utility and may be employed without reference to other features and subcombinations. This is contemplated by and within the scope of the claims.

What is claimed is:

1. One or more computer-readable media having computer-executable instructions embodied thereon for performing a method for organizing queries received through a question and answer environment, the method comprising:
receiving a query;
associating at least one tag with the received query;
storing the query in association with the at least one tag.

2. The computer-readable media of claim 1, wherein associating at least one tag with the received query comprises:
analyzing the received query based upon at least one of unit frequency and relative unit proximity;
comparing the at least one of unit frequency and relative unit proximity to a plurality of other queries to determine at least one of the plurality of other queries that is most closely related to the received query, wherein each of the plurality of other queries includes at least one tag associated therewith; and
associating the at least one tag associated with the at least one of the plurality of other queries that is most closely related to the received query with the received query.

3. The computer-readable media of claim 1, wherein associating at least one tag with the received query comprises:
presenting a plurality of tag options to a user;
receiving a user selection of at least one of the plurality of tag options; and
associating the at least one of the plurality of tag options selected by the user with the received query.

4. The computer-readable media of claim 3, wherein one or more of the plurality of tag options is automatically selected upon presenting the plurality of tag options to the user, and wherein the one or more of the plurality of tag options that is automatically selected is configured to be de-selected upon receiving appropriate user instruction.

5. The computer-readable media of claim 4, further comprising:
assigning a confidence score based upon relative similarity to the received query to each of the plurality of tag options presented to the user; and
determining the one or more of the plurality of tag options that is automatically selected upon presenting the plurality of tag options to the user based upon the assigned confidence scores.

6. The computer-readable media of claim 1, wherein associating at least one tag with the received query comprises:
receiving user identification of at least one tag; and
associating the at least one user-identified tag with the received query.

7. The computer-readable media of claim 1, further comprising receiving at least one response to the received query from a response author.

8. The computer-readable media of claim 7, further comprising:
presenting the received query and the received at least one response;
receiving feedback to the presented at least one response; and
assigning a ranking to the response author based upon the received feedback.

9. The computer-readable media of claim 1, further comprising:
receiving at least one subscription to the at least one tag, the at least one subscription being associated with a first user; and
notifying the first user upon associating the at least one tag with the received query.

10. The computer-readable media of claim 9, further comprising:
determining at least one other tag that is similar to the at least one tag associated with the received query;
receiving a second query;
associating the second query with the at least one other tag; and
notifying the first user upon associating the second query with the at least one other tag.

11. A computerized system for organizing queries, the system comprising:
a receiving component configured to receive at least one query through a question and answer environment;
a query tagging component configured to associate the at least one query with at least one tag; and
a database for storing the at least one query in association with the at least one associated tag, wherein the database is searchable for one or more of the at least one query and the at least one tag.

12. The system of claim 11, further comprising:
an analyzing component configured to analyze the received query based upon at least one of unit frequency and relative unit proximity; and
a comparing component configured to compare the at least one of unit frequency and relative unit proximity to a plurality of other queries to determine at least one of the plurality of other queries that is most closely related to the received query,
wherein each of the plurality of other queries includes at least one tag associated therewith,
and wherein the query tagging component is further configured to associate the at least one tag associated with the at least one of the plurality of other queries that is most closely related to the received query with the received query.

13. The system of claim 11, further comprising a presenting component configured to present one or more of the received query, the at least one tag associated with the received query, one or more of a plurality of other queries determined to be related to the received query, at least one tag associated with the one or more of the plurality of other queries, at least one response to the received query, and at least one response to the one or more of the plurality of other queries.

14. The system of claim 11, further comprising a response receiving component configured to receive at least one response to the received query from a response author.

15. The system of claim 14, further comprising a feedback receiving component configured to receive feedback related to the at least one response to the received query and to rank the response author based upon the received feedback.

16. The system of claim 11, further comprising:
a subscription component configured to receive at least one subscription to the at least one tag, the at least one subscription being associated with a first user; and
a notifying component configured to notify the first user upon associating the at least one tag with the received query.

17. A user interface for associating at least one tag with a query received through a question and answer environment, the user interface comprising:
a query display area configured to display at least one received query;
a suggested tag display area configured to display at least one tag suggested for association with the at least one received query; and
a related queries display area configured to display at least one query related to the received query, wherein the at least one related query is determined based upon at least one of unit frequency and relative unit proximity.

18. The user interface of claim 17, wherein the suggested tag display area is further configured to display a user-input receipt area configured to receive at least one user-defined tag.

19. The user interface of claim 17, wherein the related queries display area is further configured to display at least one tag associated with the at least one related query.

20. The user interface of claim 19, wherein the at least one displayed tag associated with the at least one related query is configured to be selectable, and wherein upon selection of the at least one displayed tag associated with the at least one related query, a plurality of other queries associated with the displayed tag are displayed.
